(19) United States
(12) Patent Application Publication
(10) Pub. No.: US 2024/0109277 A1
(43) Pub. Date: Apr. 4, 2024

(54) METHOD FOR PRODUCING A MULTI-LAYER SUBSTRATE

(71) Applicant: HENKEL AG & CO. KGAA, Duesseldorf (DE)

(72) Inventors: Roland BOCHNIA, Hilden (DE); Stefan STRENGER, Heiligenhaus (DE); Rainer BONGERS, Frankfurt (DE); Mario ECKERS, Wegberg (DE)

(21) Appl. No.: 18/494,859

(22) Filed: Oct. 26, 2023

Related U.S. Application Data
(63) Continuation of application No. 16/988,812, filed on Aug. 10, 2020, now Pat. No. 11,833,788.
Application No. 16/988,812 is a continuation of application No. PCT/EP2019/053056, filed on Feb. 7, 2019.

(30) Foreign Application Priority Data
Feb. 16, 2018 (EP) 18157071.4

(51) Int. Cl. B32B 27/08; B32B 3/06; B32B 3/18; B32B 5/16; B32B 7/05; B32B 7/12; B32B 27/10; B32B 27/30; B32B 29/04; B32B 37/00; B32B 37/12; B32B 37/14; B65D 81/03

(52) U.S. Cl. CPC B32B 27/08; B32B 3/06; B32B 3/18; B32B 5/16; B32B 7/05; B32B 7/12; B32B 27/10; B32B 27/306; B32B 29/04; B32B 37/00; B32B 37/12; B32B 37/1292; B32B 37/142; B65D 81/03; B32B 2037/243; B32B 2255/10; B32B 2255/12; B32B 2255/26; B32B 2264/303; B32B 2310/0454; B32B 2310/0825; B32B 2323/04; B32B 2331/04; B32B 2439/06; B32B 2439/46; B32B 2439/62

(57) ABSTRACT

The present invention relates to a method for producing a multi-layer substrate, said substrate comprising a multifunctional coating, and to the use of the substrate produced by this method.

### FIELD OF THE INVENTION

The present invention relates to a method for producing a multi-layer substrate, said substrate comprising a multifunctional coating, and to the use of the substrate produced by this method.

The Internet as a distribution channel for goods of all kinds has become increasingly important in recent years. Clothing, electronics, computers and shoes make up the largest share of goods sold on the Internet, but household goods, furniture and interior furnishings as well as everyday goods such as food, drugstore items and pet supplies are increasingly being purchased via the Internet. In order for the goods to reach the customer, not only complex logistics are required, but also safe transport so that sensitive or fragile goods arrive at the customer without damage.

### BACKGROUND OF THE INVENTION

Safe packaging of the goods can be achieved, for example, with the aid of suitable packaging material, the packaging material generally having a type of padding by which the goods to be transported are protected. A classic example of such a packaging material is an air cushion film, that is to say a plastic film which has pockets filled with air, by means of which mechanical vibrations can be cushioned. However, these bubble wrap films have the disadvantage that they are usually made from petroleum-based plastics and their production and disposal involve major ecological interventions. This problem is exacerbated in view of the increasing need and the increasing desire for sustainability. There is therefore a need for alternative packaging materials that have the same properties but show better environmental compatibility.

WO 2014/051876 describes an adhesive composition which is used for producing packaging materials, the adhesive composition having microspheres which have an insulating effect.

DE 20 2011109 020 describes a composite body consisting of a carrier substrate made of natural fibers and at least one bonded substrate layer made of a flexible film-shaped substrate, which are completely bonded to a dried adhesive layer, the adhesive layer being produced from an aqueous foamed adhesive.

WO 2010/129493 discloses an inflatable mailing bag that has an inflatable liner and a connector through which the liner can be inflated.

The materials described in the prior art are generally only accessible through complex production processes, as a result of which the amount that can be produced is limited. Furthermore, the conventional materials have the disadvantage that they have a large volume due to the cushion layer introduced, which can cause high costs, in particular when the material is transported and stored.

### BRIEF SUMMARY OF THE INVENTION

The object of the present invention is therefore to provide a method which allows the production of a packaging material which can absorb mechanical shocks and can be easily stored and transported.

It has surprisingly been found that this object is achieved by a method for producing a multi-layer substrate which has a multifunctional coating.

A first object of the present invention is therefore a method for producing a multi-layer substrate comprising the following steps:
a) Providing a first material having a first surface with at least one edge region and at least one inner region enclosed by the edge region;
b) Applying a coating material to the inner region of the first surface, the coating material comprising expandable microparticles;
c) Drying the coating material;
d) Contacting the first surface of the first material with a surface of a second material to form the multi-layer substrate such that the coating material is between the first material and the second material.

It has surprisingly been found that a substrate with a small volume is accessible in this way. The method according to the invention is further characterized in that it allows the substrate to be produced in large quantities and can be carried out without the need for complex modifications to the device used.

In a preferred embodiment, the first material has more than one inner region.

The coating material is preferably applied over the entire surface. For the purposes of the present invention, this is to be understood to mean application in such a way that the entire inner region is covered with the coating material. In order to save costs and material, it can be advantageous to apply the coating material intermittently or only partially, so that the inner region is not completely covered. An alternative embodiment is therefore preferred, in which the coating material is partially applied to the inner region.

In a preferred embodiment, the contacting of the first and the second material takes place using an adhesive. The adhesive is preferably applied to the edge region of the first surface before the contacting of the first and the second material. The adhesive is particularly preferably applied uniformly or continuously to the edge region of the first surface, so that the edge region is completely covered with the adhesive. It has surprisingly been found that the composite adhesion of the materials in the substrate can be improved in this way without the performance of the coating material being impaired. The advantages of the method according to the invention come to full development when it is ensured that no adhesive gets onto the inner region.

In a preferred embodiment of the method according to the invention, the first and the second material are provided in the form of continuous webs. In an alternative preferred embodiment, the first material is divided into individual units before or after application of the coating material, which have an edge region and an inner region enclosed by the edge region. In an alternative preferred embodiment, the division of the first material and the application of the coating material to the inner region take place simultaneously. In terms of process technology, the cutting is combined with the application of the coating material and is preferably carried out in a combined step.

In a preferred embodiment, the first material is selected from the group consisting of material based on cellulose, plastic and metal. The first material can have synthetic fibers, for example, in order to increase the stability of the material.

The first material is particularly preferably a material based on cellulose. In particular, the first material is selected from the group consisting of paper, cardboard and coated paper.

In a preferred embodiment, the second material is selected from the group consisting of material based on cellulose, plastic and metal. The second material can have synthetic fibers, for example, in order to increase the stability of the material.

The second material is particularly preferably a material based on cellulose. In particular, the second material is selected from the group consisting of paper, cardboard and coated paper.

In a preferred embodiment, the first and second materials are paper. The second material is particularly preferably present in the form of a continuous web.

### BRIEF DESCRIPTION OF THE DRAWINGS

FIG. 1 shows schematically the first material in the form of a continuous web, wherein (1) denotes the edge region and (2) the inner region.

FIG. 2 shows schematically the first material in the form of a single unit, wherein (1) denotes the edge region and (2) the inner region.

### DETAILED DESCRIPTION OF THE INVENTION

The method according to the invention is distinguished by its rapid process control, which allows large quantities of the multi-layer substrate to be produced in a short time. This is achieved, among other things, by carefully coordinating the properties of the materials used. Therefore, an embodiment of the present invention is preferred in which the drying of the coating material is carried out at a temperature of 80° C. or less, preferably at a temperature of 40° C. to 75° C. It has surprisingly been found that rapid drying is achieved at these temperatures without the performance of the coating material being impaired, as a result of which the process throughput is improved.

The best results in terms of process throughput were achieved when a polymer-based coating material was used. An embodiment is therefore preferred in which the coating material is a polymer-based coating material which has 10 to 40 wt. %, preferably 15 to 35 wt. % of expandable microparticles, in each case based on the total weight of the coating material. It has surprisingly been found that such a coating material can be applied at a high speed, but at the same time has sufficient stability so that it does not run after application.

The coating material used in the method according to the invention has expandable microparticles. The microparticles preferably have a particle size, expressed as a D50 value, of 5 to 18 μm, preferably 10 to 17 μm, in the unexpanded state.

The expandable microparticles are preferably thermally expandable microparticles, which preferably have the shape of spheres.

In a preferred embodiment of the method according to the invention, the multi-layer substrate is converted into packaging in a further step. This implementation can take place, for example, by cutting and folding the multi-layer substrate. The packaging is preferably an envelope, a mailing bag, a bag, a carrier bag, a pouch or a carton, the format and size being variable. In a particularly preferred embodiment, the packaging is a mailing bag.

In a preferred embodiment, the method according to the invention comprises a further step in which the multi-layer substrate is subjected to a treatment for expanding the expandable microparticles.

In a preferred embodiment, the heat treatment step follows step d) of the method according to the invention.

The method according to the invention allows the production of a substrate, the volume of which can be increased by a heat treatment, wherein this heat treatment can be carried out independently of the production method. In a preferred embodiment, the heat treatment is carried out separately from the other method steps in terms of time and/or location. In this way it is possible to transport and store the substrate in the state of a small volume. The substrate reaches its final volume as a result of the heat treatment, which causes the microparticles of the coating material to expand. The method according to the invention makes it possible to carry out the heat treatment only shortly before the substrate is used, which was not possible with conventional methods described in the prior art. For example, the substrate can be further processed into a mailing bag, which takes up little space due to the small volume and the small thickness. Before the mailing bag is used, it can be subjected to a heat treatment, whereby the microparticles are expanded and the mailing bag develops its desired cushioning effect. In this way, valuable storage and transport capacity can be saved by the method according to the invention.

The heat treatment is preferably carried out at temperatures from 85° C. to 150° C., preferably 90 to 140° C. This ensures that the microparticles fully expand without being damaged and without losing their shock-absorbing effect.

In order to achieve optimal absorption of mechanical influences, it has proven to be advantageous if the microparticles in the expanded state have a particle size in the range from 20 μm to 200 μm. An embodiment is therefore preferred in which the microparticles in the expanded state have a particle size, expressed as a D50 value, of 20 μm to 200 μm, preferably 20 to 150 μm.

The heat treatment is preferably carried out using conventional heat sources. The heat treatment is particularly preferably carried out using infrared radiation and/or warm air.

The multi-layer substrate produced by the method according to the invention is distinguished by its flexible volume. Another object of the present invention is therefore a multi-layer substrate which can be obtained by the method according to the invention. The substrate according to the invention is preferably in the form of a continuous web. In an alternative preferred embodiment, the substrate according to the invention is in the form of a packaging, preferably in the form of an envelope, a mailing bag, a bag, a carrier bag, a pouch or a carton, the format and the size being variable.

The substrate according to the invention can be easily processed into packaging. Another object is therefore a method for producing a package using a multi-layer substrate which has been produced by the method according to the invention, the multi-layer substrate being formed into a package by means of cutting and folding.

Another object of the present application is a package obtainable according to the inventive method. The packaging is preferably an envelope, a mailing bag, a bag, a carrier bag, a pouch or a carton, the format and the size being variable.

The present invention is to be explained in more detail with reference to the following example, which is in no way to be understood as a restriction of the inventive concept.

A suitable coating material can contain 30 to 70 wt-% of VAE copolymer dispersion (Vinamul® 3928), 5 to 15 wt. % of paraffin dispersion (Michemlube® 743 PE), 15 to 30 wt. % of microparticles (Expancel® 031 WUF 40), 5 to 10 wt. % of glycerol and optionally up to a wt. % of hydroxyethylcellulose (MEHC, Natrosol® 250LR), wherein the weight percentages refer to the total weight of the coating material and add up to 100 wt. %.

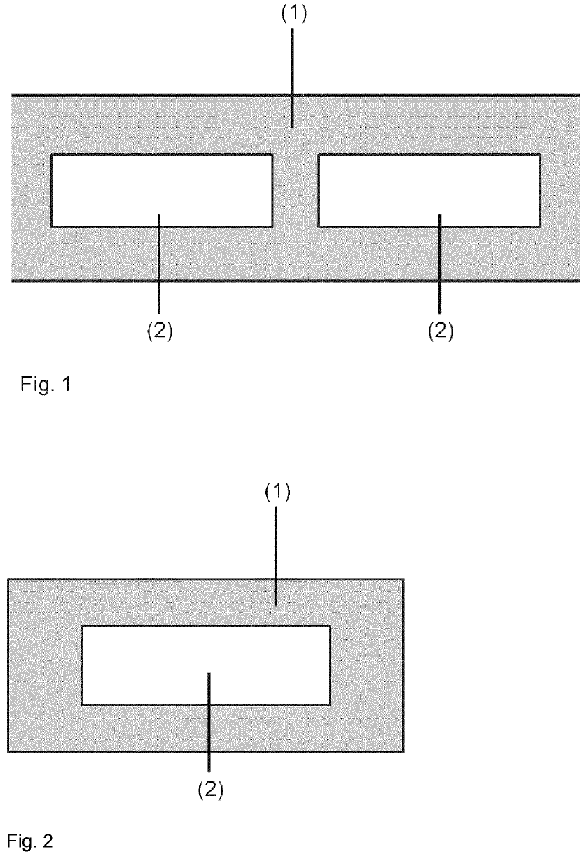

FIG. 1 shows schematically the first material in the form of a continuous web, wherein (1) denotes the edge region and (2) the inner region.

FIG. 2 shows schematically the first material in the form of a single unit, wherein (1) denotes the edge region and (2) the inner region.

1: A method of producing a multi-layer substrate comprising the following steps:
a) providing a first material having a first surface with at least one edge region and at least one inner region enclosed by the edge region;
b) applying a coating material to partial portions of the inner region of the first surface, the coating material comprising expandable microparticles;
c) drying the coating material; and
d) contacting the first surface of the first material with a surface of a second material to form the multi-layer substrate such that the coating material is between the first material and the second material,
wherein the inner region does not contain an adhesive
wherein the coating material consists of:
(i) 30 to 70 wt-% of VAE copolymer dispersion;
(ii) 5 to 15 wt. % of paraffin dispersion;
(iii) 15 to 30 wt. % of microparticles;
(iv) 5 to 10 wt. % of glycerol; and
(v) optionally, hydroxyethylcellulose,
wherein the total weight of the coating material and add up to 100 wt. %.

2: A multi-layer substrate which can be obtained by a method according to claim 1.

3: The multi-layer substrate according to claim 2, characterized in that the substrate is in the form of a continuous web or packaging.

4: A packaging obtainable by a method according to claim 1.
